(19) United States
(12) Patent Application Publication
(10) Pub. No.: US 2003/0097772 A1
(43) Pub. Date: May 29, 2003

(54) Excavation cleanup device

(76) Inventor: Keith Christensen, South Weber, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/304,725

(22) Filed: Nov. 26, 2002

Related U.S. Application Data
(60) Provisional application No. 60/333,935, filed on Nov. 28, 2001.

(51) Int. Cl. B62B 1/00

(52) U.S. Cl. 37/304; 280/47.31

(57) ABSTRACT

An excavation cleanup device is provided that includes a frame configured to support a collection tray that defines a through opening with a fence extending therearound. The through opening is configured and arranged to admit excavation devices such as augers. The collection tray has a low profile configuration that permits it to lie flat on the ground during the excavation process, and further includes an outer rim that cooperates with the fence to aid in the retention of materials deposited on the collection tray by the excavation device. The low profile construction of the collection tray also serves to minimize the risk of interference between the excavation cleanup device and the device used to perform the excavation process. The excavation cleanup device further includes a pair of handles and a wheel, to facilitate ready transportation of the excavation cleanup device from one site to another.

### CROSS-REFERENCE TO RELATED APPLICATIONS

This application hereby claims priority to U.S. Provisional Patent Application Serial No. 60/333,935, entitled EXCAVATION CLEANUP DEVICE, filed Nov. 28, 2001, and made a part hereof and incorporated herein in its entirety by this reference.

### BACKGROUND OF THE INVENTION

1. Field of the Invention

The present invention relates generally to tools for use in excavation and/or related processes. More particularly, embodiments of the present invention relate to devices and systems that facilitate management and clean up of materials generated or relocated as a result of excavation processes.

2. Related Technology

Excavation processes, such as are performed in connection with landscaping or the construction or installation of various structures, can be implemented in various ways. Many of such excavation processes involve digging holes of varying size and/or depth, such as for the placement of posts or other structures. Post hole diggers, shovels and augers are examples of tools that are commonly employed to this end. While such tools are relatively effective, an inevitable consequence of such excavation operations is that a volume of excavated materials is generated that must be removed.

Moreover, it is often the case that hole excavations are required to be performed in areas where it is desired to substantially minimize, or avoid altogether, the deposition of materials such as may be generated or relocated during the excavation process. By way of example, it is sometimes necessary to dig or otherwise excavate holes in areas, such as landscaped grounds or lawns, where the deposition, presence, and/or removal of excavation materials could cause damage to the surrounding grounds or lawn.

Thus, it is often desirable to excavate the hole as cleanly as possible, minimizing or eliminating deposition of dirt and other excavated materials on landscaped areas, or other areas where the presence of excavation materials would be undesirable. Typically, however, cleanliness of the areas proximate the excavated hole is achieved only after the fact. That is, after the hole has been excavated, the dirt or other material that has been deposited in the surrounding area as a result of the excavation process must then be manually removed, such as with a shovel and/or rake. Such manual removal processes are time consuming however, and may not result, in all cases, in satisfactory removal of the deposited excavation materials. As suggested above, manual removal processes can also damage the lawn or other surface upon which the excavation materials have been deposited.

It may be possible in some cases to collect the dirt or other excavated materials on a tarp or similar device or structure disposed near the excavation site. However, while a tarp may provide some assistance in preventing the dirt or other materials from coming into contact with landscaped areas, or other areas that are to be protected or isolated from the excavation materials, a tarp may not be effective in containing large amounts of material because the tarp lacks features that would materially assist in the retention, confinement, and transportation of the excavated material.

For example, once the hole has been excavated and the excavation material deposited on the tarp, it is difficult to readily transport the tarp and excavated materials to the desired dumping area, at least because there is no way to easily move or maneuver the tarp when it is covered with excavation materials that may be quite heavy. These issues, at least, are of particular concern where the hole to be excavated is relatively large and/or where multiple holes are to be excavated.

In addition to the fact that collecting and removing dirt or other excavation materials by way of a tarp or similar device is inconvenient, such processes can be quite time consuming. As a result, this type of approach to excavation clean up, as well as manual clean up processes, may result in substantially increased costs due to the additional time and effort required to effectuate clean up. The additional time required for cleanup may also adversely affect the schedule and/or the timing associated with a particular project. Such schedule delays may also impose additional costs, such as in the form of delay penalties.

In light of the foregoing, and other, considerations, what is needed is an excavation cleanup device having various features directed to addressing the exemplary concerns noted herein, as well as other concerns not specifically enumerated. The exemplary excavation cleanup device should be of simple and light-weight construction and should be capable of, among other things, facilitating effective and efficient collection, containment, and transportation of materials produced during excavation processes.

### BRIEF SUMMARY OF AN EXEMPLARY EMBODIMENT OF THE INVENTION

In general, embodiments of the present invention relate to devices and systems that facilitate management and clean up of materials generated or relocated as a result of excavation processes.

In one exemplary embodiment of the invention, an excavation cleanup device is provided that includes a collection tray defining a through opening with a fence extending therearound. The collection tray has a low profile configuration that permits it to lie flat on the ground during the excavation process and includes an outer rim that aids in the retention of materials deposited on the collection tray. The low profile construction of the collection tray also serves to minimize the risk of interference between the excavation cleanup device and the device used to perform the excavation process. This exemplary embodiment of the excavation cleanup device further includes a pair of handles, as well as a wheel, to facilitate ready transportation of the excavation cleanup device from one site to another.

In operation, the through opening of the collection tray is positioned over the area where it is desired to excavate the hole. An auger, post hole digger, or other device suitable for excavating a hole is then inserted into the through opening. As materials are removed by the excavating device, they are deposited on the collection tray. The fence around the through hole prevents such removed materials from re-entering the hole by way of the opening, and further cooperates with the rim of the collection tray to prevent such removed materials from escaping the collection tray and on to the surrounding area. After excavation is completed, the excavating device is removed from the hole and the collection tray may then be transported to a desired location. The fence and rim of the collection tray cooperate to ensure that the excavation materials are retained on the collection tray during transportation.

In this way, the excavation cleanup device serves to, among other things, effectively and efficiently capture and contain materials produced during the excavation process, as well as facilitate ready removal of the excavation materials from the excavation area.

The foregoing, and other, aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a top view illustrating various aspects of an exemplary embodiment of an excavation cleanup device;

FIG. 2 is a bottom view illustrating various aspects of an exemplary embodiment of an excavation cleanup device;

FIG. 3 is a perspective view illustrating disposition of an exemplary embodiment of an excavation cleanup device prior to performance of an excavation process;

FIG. 4 is a perspective view illustrating disposition of an exemplary embodiment of an excavation cleanup device during the performance of an excavation process; and

FIG. 5 is a perspective view illustrating disposition of an exemplary embodiment of an excavation cleanup device upon completion of an excavation process.

### DETAILED DESCRIPTION OF SELECTED EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

The present invention relates generally to devices and systems that facilitate clean up and management of materials generated or relocated as a result of excavation processes. At least some embodiments of the invention are particularly well suited for use in conjunction with the digging of holes such as for posts and other structures which are desired to be placed at least partially below ground level. As described below, embodiments of the invention permit management and cleanup of materials generated during excavation projects by way of an excavation cleanup device that includes a collection tray configured to at least partially receive the excavating device and thereby permit the excavating device to deposit removed materials on the collection tray. Upon completion of the excavation process, the excavation cleanup device can then be readily transported to a dump site.

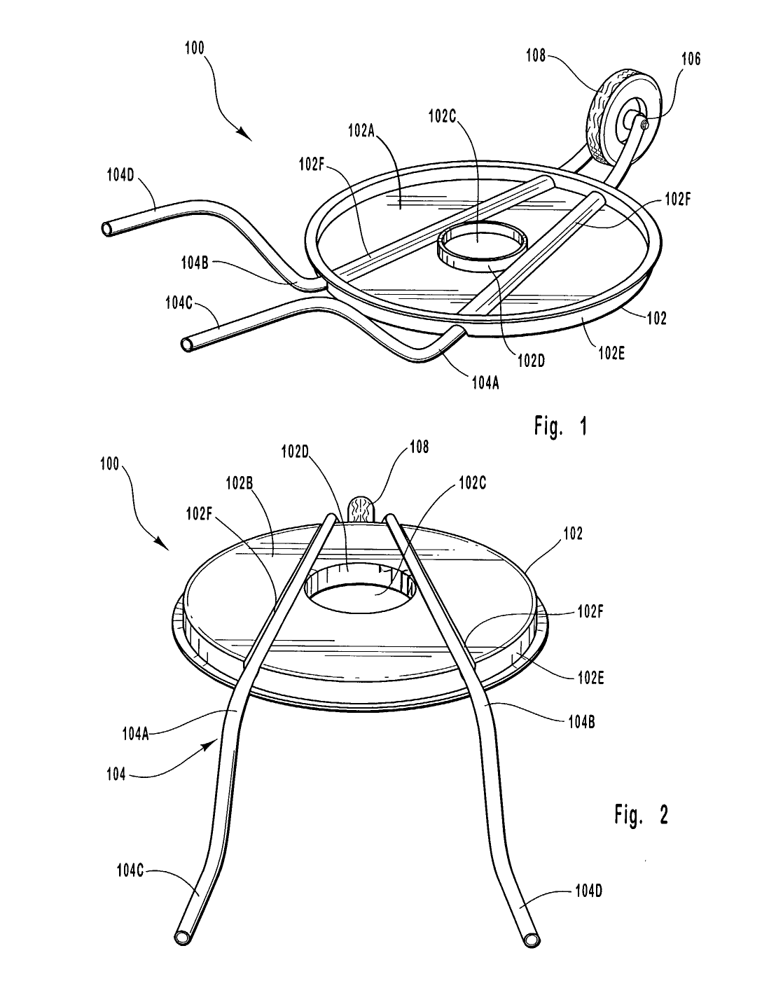

Directing attention now to FIGS. 1 and 2, details are provided concerning an exemplary embodiment of an excavation cleanup device, generally denoted at 100. The illustrated embodiment of the excavation cleanup device 100 generally includes a collection tray 102 which is attached to a frame 104 that, among other things, supports the collection tray 102 and is attached thereto by bolts, screws, clamps or other devices of comparable functionality. The frame 104 additionally supports either end of an axle 106 upon which is mounted a wheel 108, such as a hard rubber wheel, or a pneumatic tire.

With general reference now to the construction and geometry of the collection tray 102, variables such as, but not limited to, the size, geometry, and positioning of the collection tray 102 may be varied as necessary to suit a particular application and/or operating environment. Moreover, the collection tray 102, as well as the other components of the excavation cleanup device 100, may comprise any of a variety of materials such as plastic, metal, or wood, or combinations thereof, and may be formed by various processes including, but not limited to, injection molding. Note that while the illustrated embodiment of the collection tray 102 is substantially circular in shape, the scope of the invention is not so limited, and any other shape or geometry effective in facilitating implementation of the functionality disclosed herein may likewise be employed.

Directing more particular reference to various details of the collection tray 102, the illustrated exemplary embodiment of the excavation cleanup device 100 includes a collection tray 102 having opposing upper and lower surfaces 102A and 102B through which is defined a through opening 102C exemplarily positioned proximate the center of the collection tray 102, and sized and shaped to readily accommodate various types of excavation devices which may include, among others, shovels, post hole diggers, and augers. More generally however, the through opening 102C may be sized and/or positioned in any way that is effective in facilitating implementation of the functionality disclosed herein.

Disposed about the through opening 102C defined by the collection tray 102 is a fence 102D which, exemplarily, is integral with the collection tray 102. Alternatively however, the fence 102D may comprise a component discrete from, but attached or attachable to, the collection tray 102. Aspects of the fence 102D geometry, such as the fence height for example, may be varied as necessary. Moreover, at least some embodiments of the invention provide for a collar 103 configured to be removably attached to the fence 102D and to extend upward a predetermined distance when thus attached, so as to extend the height of the fence 102D. Such a collar 103 proves useful where, for example, a relatively large amount of materials are anticipated to be deposited on the collection tray 102.

In at least some embodiments of the invention, the collection tray 102 further includes a rim 102E or similar structure, exemplified as an upwardly extending flange, disposed proximate an outer perimeter of the collection tray 102 and configured and arranged so that the rim 102E serves to prevent materials deposited on the collection tray 102 from falling off of the collection tray 102 and onto the surrounding area. The height of the rim 102E may be varied as desired. For example, in some embodiments of the invention, the rim 102E extends only a relatively short distance above the bottom of the collection tray 102 while, in other exemplary embodiments, the rim 102E extends upwardly and inwardly toward the through opening 102C so as to cooperate with the collection tray 102 to define a substantially enclosed space generally in the shape of a hemisphere.

In one exemplary embodiment, the collection tray 102 is formed so that the perimeter of the collection tray 102 curves upward somewhat, thereby forming a rim 102E that is integral with the collection tray 102. In yet other embodiments, the rim 102E comprises a discrete component attached proximate the outer perimeter of the collection tray 102. Thus configured and arranged, the rim 102E and the fence 102D cooperate with each other in the retention of materials deposited on the collection tray 102.

In at least some alternative embodiments of the invention, the collection tray 102 defines a conical cross-section such that when the collection tray 102 is resting in a relatively level disposition, the portion of the collection tray 102 proximate the fence 102D is somewhat higher than the portion of the collection tray 102 proximate the rim 102E. When the collection tray 102 is configured in this way, materials deposited on the collection tray 102 will tend to slide downward to the rim 102E, leaving the area of the upper surface 102A proximate the fence 102D relatively clear for the deposit of additional excavation materials.

As suggested above, the fence 102D and the rim 102E, either alone or in combination with each other, thus comprise but one exemplary structural implementation of a means for retaining materials deposited on the collection tray 102. However, any other structure or combination of structures suitable to implement the functionality disclosed herein may alternatively be employed.

In connection with the functionality afforded by the fence 102D and the rim 102E, yet other exemplary embodiments of the invention additionally, or alternatively, include a clamshell or other type of cover that can be removably attached to the collection tray 102 such as by quick release clips or devices of comparable functionality. Such a clamshell cover aids in preventing materials from blowing away on a windy day, and/or otherwise assists in containing and confining the materials that have been deposited upon the collection tray 102.

With continuing reference to FIGS. 1 and 2, the illustrated embodiment of the collection tray 102 further defines two corresponding recesses 102F, each of which is configured and arranged to partially receive a portion of the frame 104. Among other things, this arrangement results in a relatively flat bottom surface 102B and further allows a substantial portion of bottom surface 102B of the collection tray 102 to be in contact with the ground, or other surface, in a relatively level disposition, thereby aiding the overall stability of the excavation cleanup device 100 and helping to ensure that materials deposited on the collection tray 102 during excavation do not spill or slide off of the collection tray 102. The exemplary location of at least a portion of the wheel 108 above the collection tray 102 is likewise useful in this regard.

In other arrangements, no such recesses 102F are defined by the collection tray 102. Rather, substantially all of the collection tray 102 resides on top of the frame 104. In yet other exemplary arrangements, the frame 104 at least partially defines a circular configuration that supports a portion of, or all of, the rim 102E of the collection tray 102.

With continuing reference to aspects of the exemplary frame 104, a variety of construction materials may be employed in the construction thereof. Such materials exemplarily comprise lightweight metals such as aluminum, or may alternatively comprise any other material(s), such as steel, wood or fiberglass, consistent with the application or environment wherein the excavation cleanup device is to be employed.

In the illustrated embodiment, the frame 104 is configured to include first and second frame members 104A and 104B, each of which include respective upwardly curving portions that terminate in a corresponding integral handle 104C and 104D such as may be grasped by the user for maneuvering the excavation cleanup device 100. In some alternative arrangements, the handles comprise discrete components attached to the frame.

As indicated in FIGS. 1 and 2, the first and second frame members 104A and 104B of frame 104 are exemplarily disposed in a non-parallel arrangement so that the handles are relatively further apart than those portions of the first and second frame members 104A and 104B that support the axle 106. Such an arrangement contributes to the stability of the excavation cleanup device 100 when loaded and in transit. This is a useful aspect in situations where, for example, the load of excavation materials on the collection tray 102 is relatively heavy and/or not evenly distributed. Moreover, the relatively low center of gravity of exemplary embodiments of the excavation cleanup device 100 is likewise useful in this regard.

It should be noted that the frame 104 and handle configuration and arrangement illustrated in FIGS. 1 and 2, among others, is exemplary only and is not intended to limit the scope of the invention in any way. More generally, any structure, or combination thereof, effective in facilitating implementation of the functionality disclosed herein may alternatively be employed.

As noted earlier, the frame 104 is exemplarily configured to support an axle 106 upon which is disposed a wheel 108. Among other things, the handles 104C and 104D attached to frame 104, in combination with the wheel 108, permit the excavation cleanup device 100 to be readily maneuvered and moved to a desired dumping location at such time as the excavation process has been completed, or the collection tray 102 is filled to capacity. Various alternative devices, such as rollers or tires, may be employed in place of wheel 108.

It should be noted in this regard that, as used herein, ‘wheel’ refers to wheels, tires, rollers, and any other device, or combination thereof, of comparable functionality. Moreover, a wheel comprises an exemplary structural implementation of a means for facilitating transport of the excavation cleanup device. Any other structure or combination thereof effective in implementing such functionality may alternatively be employed.

In at least some implementations, the wheel 108 is removable so that the excavation cleanup device 100 can be easily maneuvered and transported over relatively slick surfaces such as snow and ice, where wheels may not be particularly effective. Yet other embodiments may additionally or alternatively include structures, similar to skis or skids for example, to that end.

In addition to the foregoing exemplary implementations of the excavation cleanup device 100, various other configurations may alternatively be employed. For example, in one alternative embodiment, the excavation cleanup device 100 generally comprises a unified construction substantially embodied as a collection tray with integral handles, and further includes one or more wheels, or devices of comparable functionality. Such a unified construction may be achieved through the use of a variety of processes, such as injection molding, and may comprise materials such as high impact plastics or similar materials.

In another alternative embodiment, an excavation cleanup device 100 is provided that includes a standardized frame and a set of collection trays, each of which defines a through opening having a size and geometry that correspond with the geometry of a particular excavating device. One aspect of such an implementation is that the excavation cleanup device 100 can readily be adapted to conform with the requirements of a particular excavating device, without necessitating the purchase of a separate excavation cleanup device 100 for each excavation device that is desired to be employed.

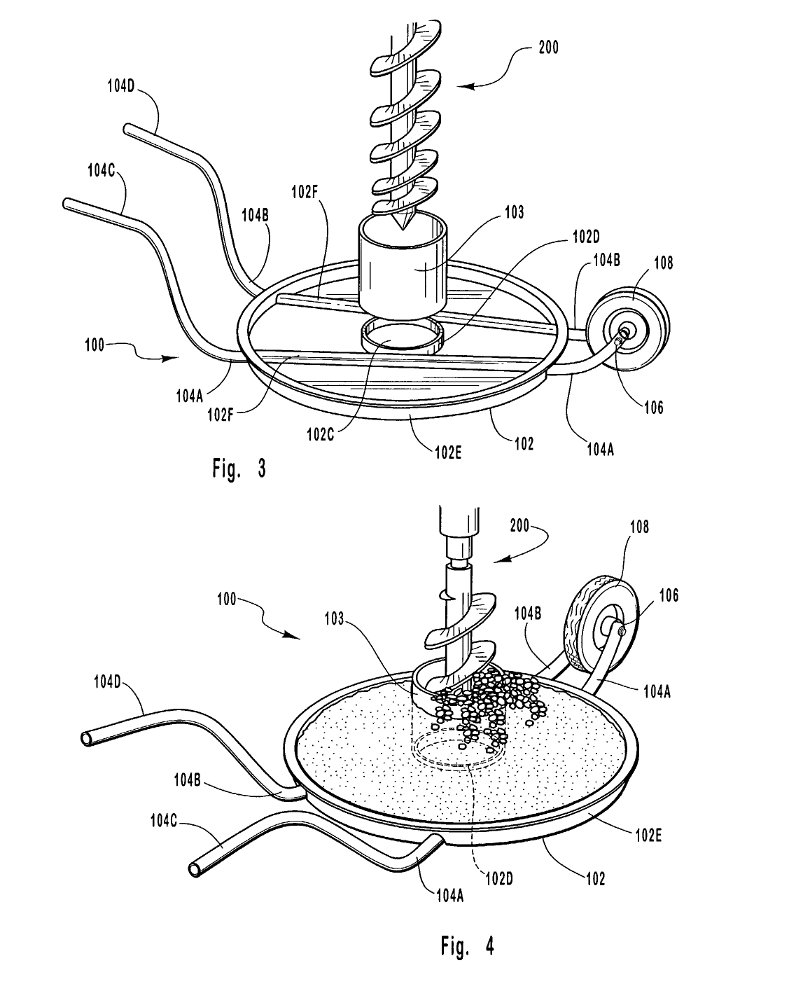

Directing attention now to FIGS. 3 through 5, details are provided concerning various operational aspects of an exemplary embodiment of the excavation cleanup device 100. With particular reference first to FIG. 3, the excavation cleanup device 100 is shown positioned in anticipation of the performance of an excavation process where an auger 200 is positioned above, and aligned with, the collar 103 and the through opening 102C of the collection tray 102.

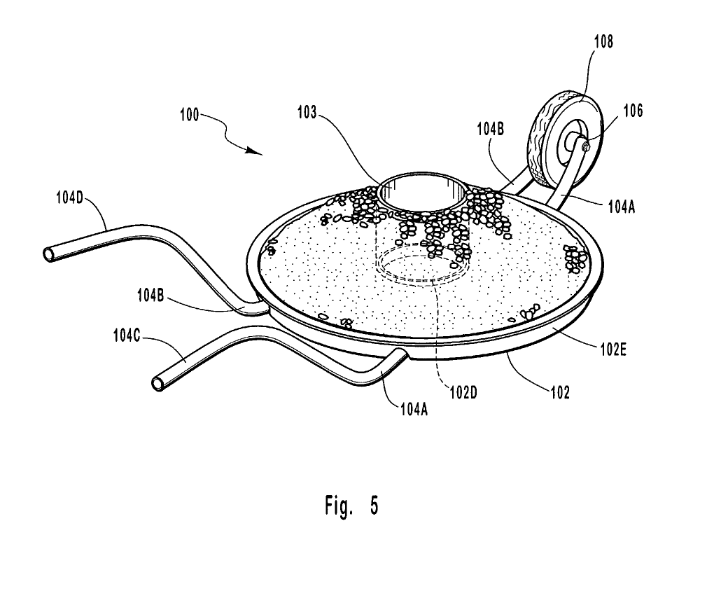

In FIG. 4, the excavation cleanup device 100 is shown with an auger 200 at least partially received within the through opening 102C. As the auger 200 rotates, the screw configuration of the auger 200 pulls dirt and other materials to the surface where it falls from the auger 200 into the collection tray 102. At the same time, the fence 102D and the rim 102E cooperate to prevent the excavated materials from falling back into the excavated hole or off the collection tray 102, as further suggested in FIG. 5. Upon completion of the excavation process and removal of the auger 200, the excavation cleanup device 100 can then be transported to an appropriate dumping site.

Among other things then, embodiments of the invention are effective in capturing and retaining a substantial portion of the materials such as are typically generated or relocated during excavation processes, thereby precluding the need for time-consuming, and potentially damaging, clean up processes. Moreover, embodiments of the invention are likewise well-suited for use in conjunction with the various tools and systems commonly employed in such excavation procedures, and can thus be usefully employed in a variety of different situations. Finally, the portability of embodiments of the excavation cleanup device 100 contributes to the ease with which excavation materials can be removed from the excavation site.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. An excavation cleanup device, comprising:
a collection tray defining a through opening;
means for retaining materials deposited on the collection tray;
at least one handle at least indirectly attached to the collection tray; and
means for facilitating transport of the excavation cleanup device.

2. The excavation cleanup device as recited in claim 1, wherein the means for retaining materials deposited on the collection tray comprises:
a fence substantially disposed about the through opening and attached to the collection tray; and
a rim substantially disposed about an outer perimeter of, and attached to, the collection tray.

3. The excavation cleanup device as recited in claim 2, wherein at least one of the following is integral with the collection tray: the fence; and, the rim.

4. The excavation cleanup device as recited in claim 1, wherein the through hole defined by the collection tray is substantially circular.

5. The excavation cleanup device as recited in claim 1, wherein the at least one handle is integral with the collection tray.

6. The excavation cleanup device as recited in claim 1, wherein the collection tray defines an upper surface substantially in the shape of a cone.

7. The excavation cleanup device as recited in claim 1, wherein the collection tray defines a bottom surface, and the collection tray and the wheel are configured and arranged such that when the excavation cleanup device is resting in a substantially level disposition on a surface, both the wheel and a substantial portion of the bottom surface of the collection tray are in contact with the surface.

8. The excavation cleanup device as recited in claim 1, further comprising a cover configured to be removably attached to the collection tray.

9. The excavation cleanup device as recited in claim 1, wherein the means for facilitating transport of the excavation cleanup device comprises a wheel at least indirectly attached to the collection tray.

10. The excavation cleanup device as recited in claim 1, further comprising a frame to which the collection tray and the at least one handle are attached.

11. An excavation cleanup device, comprising:
a frame;
a collection tray attached to the frame and defining a through opening;
means for retaining materials deposited on the collection tray;
at least one handle attached to the frame; and
a wheel at least indirectly attached to the frame.

12. The excavation cleanup device as recited in claim 11, wherein the means for retaining materials deposited on the collection tray comprises:
a fence substantially disposed about the through opening and attached to the collection tray; and
a rim substantially disposed about an outer perimeter of, and attached to, the collection tray.

13. The excavation cleanup device as recited in claim 12, wherein at least one of the following is integral with the collection tray: the fence; and, the rim.

14. The excavation cleanup device as recited in claim 11, wherein the frame comprises first and second frame members, each having first and second opposing ends, the first opposing ends collectively comprising the at least one handle, and the second opposing ends cooperating with each other to at least indirectly support the wheel.

15. The excavation cleanup device as recited in claim 14, wherein the first and second frame members substantially comprise one of the following: metal; fiberglass; wood; and, plastic.

16. The excavation cleanup device as recited in claim 14, wherein the first and second frame members are disposed in a non-parallel configuration with respect to each other.

17. The excavation cleanup device as recited in claim 11, wherein the through hole defined by the collection tray is substantially circular.

18. The excavation cleanup device as recited in claim 11, wherein the at least one handle is integral with the frame.

19. The excavation cleanup device as recited in claim 11, wherein the collection tray defines an upper surface substantially in the shape of a cone.

20. The excavation cleanup device as recited in claim 11, wherein the collection tray defines a bottom surface, and the collection tray and the wheel are configured and arranged such that when the excavation cleanup device is resting in a substantially level disposition on a surface, both the wheel and a substantial portion of the bottom surface of the collection tray are in contact with the surface.

21. The excavation cleanup device as recited in claim 11, further comprising a cover configured to be removably attached to the collection tray.

22. The excavation cleanup device as recited in claim 11, wherein the collection tray defines at least one recess wherein the frame is at least partially received.

23. An excavation cleanup device, comprising:
a frame;
a collection tray attached to the frame, the collection tray defining a through opening and including:
a fence substantially disposed about the through opening and attached to the collection tray; and
a rim substantially disposed about an outer perimeter of the collection tray and attached to the collection tray;
at least one handle attached to the frame; and
a wheel at least indirectly attached to the frame.

24. The excavation cleanup device as recited in claim 23, wherein the frame comprises at least one of: metal; wood; fiberglass; and, plastic.

25. The excavation cleanup device as recited in claim 23, wherein the collection tray comprises one of: fiberglass; metal; and, plastic.

26. The excavation cleanup device as recited in claim 23, wherein the collection tray defines at least one recess wherein the frame is at least partially received.

27. The excavation cleanup device as recited in claim 23, wherein the frame comprises first and second frame members, each having first and second opposing ends, the first opposing ends collectively comprising the at least one handle, and the second opposing ends cooperating with each other to at least indirectly support the wheel.

28. The excavation cleanup device as recited in claim 27, wherein the first and second frame members substantially comprise one of the following: metal tubing; fiberglass; wood; and, plastic.

29. The excavation cleanup device as recited in claim 27, wherein the first and second frame members are disposed in a non-parallel configuration with respect to each other.

30. The excavation cleanup device as recited in claim 23, wherein the through hole defined by the collection tray is substantially circular.

31. The excavation cleanup device as recited in claim 23, wherein the at least one handle is integral with the frame.

32. The excavation cleanup device as recited in claim 23, wherein the collection tray defines an upper surface substantially in the shape of a cone.

33. The excavation cleanup device as recited in claim 23, further comprising a cover configured to be removably attached to the collection tray.

34. The excavation cleanup device as recited in claim 23, further comprising a collar configured to be removably attached to the fence.

35. The excavation cleanup device as recited in claim 23, wherein the collection tray defines a bottom surface, and the collection tray and the wheel are configured and arranged such that when the excavation cleanup device is resting in a substantially level disposition on a surface, both the wheel and a substantial portion of the bottom surface of the collection tray are in contact with the surface.

36. The excavation cleanup device as recited in claim 23, wherein the collection tray defines at least one recess wherein the frame is at least partially received.
